(19) United States
(12) Patent Application Publication
(10) Pub. No.: US 2014/0160422 A1
(43) Pub. Date: Jun. 12, 2014

(54) Eyeglass frames having removable lens

(71) Applicant: EYE OJO CORP., Ontario, CA (US)

(72) Inventor: Shih-Hsin Chen, Taipei (TW)

(73) Assignee: EYE OJO CORP., Ontario, CA (US)

(21) Appl. No.: 13/969,475

(22) Filed: Aug. 16, 2013

(30) Foreign Application Priority Data
Nov. 7, 2012 (TW) M449276

(51) Int. Cl. G02C 1/04

(52) U.S. Cl. CPC G02C 1/04
USPC 351/105

(57) ABSTRACT

The present invention relates to the structure of eye glasses. More specifically, the frame has embedded clamps on the outside part of the front. Embedded clamps can be displaced inward or outward along the outside part of the front. When embedding the lens into the lens assembly area which consists of the inner part, upper part, and outside part of the front, the embedded clamps can be pushed outward. Upon embedding the lens in the front, the embedded clamps can be pushed inward, by this way, the front and back of the embedded clamps can clamp the front, thereby fixing the lens.

### INCORPORATION BY REFERENCE

This application claims priority under 35 U.S.C §119 to Taiwan patent application M449276, filed Nov. 7, 2012, the disclosure of which is incorporated herein by reference.

### FIELD OF INVENTION

The invention is a structure for eyeglasses. In particular, it relates to the structure and method of setting the lens and front, wherein the structure allows for the lens to be easily removed and reassembled.

### BACKGROUND

The present invention relates to eyeglasses accommodating interchangeable lenses. As it is known eyeglasses can accomplish one or more functions such as a therapeutic, ophthalmic, protective or esthetical function.

Prior to the present invention, auxiliary eyewear attachments, which connect to primary or conventional eyeglasses with magnets or clips, allow the user to convert a pair of conventional eyeglasses to sunglasses and to avoid the need for an additional pair of prescription sunglasses. This auxiliary eyewear can also be used to change the prescription of the lenses on the primary eyewear. Many current designs attach auxiliary eyewear using magnets or clips at various locations on a pair of conventional or primary eyeglasses.

However, there are several disadvantages to mounting an auxiliary set of lenses to conventional eyeglasses, which already have their own set of lenses. First, there is the additional and extra weight of the auxiliary lenses. Even with the advent of plastic lenses, the additional weight of another frame and another set of lenses may distract and cause some irritation to the user.

Second, since there are two sets of lenses, having two sets of lenses so close to one another can cause a glare or reflection. This reflection or glare can be quite annoying and can partly defeat the use of sunglasses to reduce glare and to improve the sight of the user.

Third, the space or separation between the two lenses may cause some distraction to the field of vision of the user. Many current styles of sunglasses have smaller or narrow lenses. Because the field of vision through these lenses is smaller than through larger lenses, when auxiliary lenses are attached to the primary or conventional eyewear, the user may see the difference between the two sets of lenses. This difference can be quite distracting to the user.

Fourth, people, who do not require prescription glasses, would not practically use these current auxiliary eyewear attachments without glasses. They would not be able to take advantage of the ability to switch the color of their sunglasses.

The claimed invention avoids the above problems and provides significant advantages with a new apparatus and method for attaching a removable lens frame to an eyewear platform. In the applicant's invention, the lenses themselves are removable from the eyewear platform so that the user can easily change lenses and only needs to wear only one set of lenses at a time. By only using one set of lenses in this eyewear, there is reduced weight, no glare or reflection between lenses, and no distraction in the field of vision with the applicant's invention. In addition, since there is only one set of lenses, it is easier for the user to keep these lenses clean. Further, by using the same eyewear platform as a base to attach different lenses, the user is able to employ one eyewear apparatus that allows for a multiple and different types of lenses and that can be changed easily and quickly. This instant eyewear apparatus is also comfortable to wear and easy to use. Keeping a small case with different types of lenses is easier to transport than several boxes of different eyewear. Finally, instead of having several different pairs of conventional glasses, the user may have substantial savings in cost by having different sets of lenses for one eyewear platform.

This invention allows the user to maximize the different kinds of eyewear available according to his or her need. For example, the user can easily change from reading lenses for fine print to sunglasses. Also, people, who do not need prescription lenses, can change the color of their sunglasses depending on their particular need or situation. For example, the user may require yellow lenses for driving in the mountains, but gray lenses for fishing or boating on a bright sunny day.

Also, this invention allows for effective and easy replacement of safety glasses and eyewear. By allowing for removable attachment of a lens frame with safety lenses, it is possible for the user to easily wear and to change safety lenses after these lenses become dirty, scratched, or broken. Because only the lens frame is being replaced, the user will save money in simply replacing this lens frame instead of the entire safety eyewear. In addition, this eyewear apparatus also provides the ability to change lenses quickly but also provides a stable and effective attachment to provide effective resistance to the lens frame from becoming involuntarily detached from the eyewear platform.

From the preceding descriptions, it is apparent that the devices currently being used have significant disadvantages or limitations. Thus, important aspects of the technology used in the field of invention remain amenable to useful refinement.

### SUMMARY OF THE INVENTION

In one aspect of the invention, an eyeglasses apparatus is disclosed comprising a frame and at lease one lens wherein the frame comprising a lens assembly area wherein the lens assembly area is comprised of a recess and a clamp wherein the clamp attaches to the recess to secure the lens onto the lens assembly area. In one embodiment of the invention, the recess is comprised of a one or more threaded portion on the recess and the clamp is comprised of a bore segment, an inner cover and an outer cover; wherein the bore segment is comprised of a matching threaded portion wherein the matching threaded portion matches to the threaded portion of the recess. In one embodiment of the invention, the threaded portion of the recess is comprised of at least a first area and a second area wherein the clamp is moves along the edge of the recess as the clamp's matching threaded portion matches to the second area as oppose to the first area. In one embodiment of the invention, the clamp's bore segment is integral with the outer cover. In one embodiment of the invention, the clamp is comprised of a trim area. In one embodiment of the invention, the inner cover is comprised of a hole allowing a screw to attach the inner cover to the bore segment.

### BRIEF DESCRIPTION OF THE DRAWINGS

FIG. 1 is a 3D decomposition view of the rim of the eyeglasses.

FIG. 2 is a 3D assembled view of the rim of the eyeglasses.

FIG. 3 is the section view of the structure of the eyeglasses.

FIG. 4 is a the section view of the structure of eyeglasses-foresight drawing(the clamp does not clamp the lens).

FIG. 5 is the section view of the structure of eyeglasses-foresight drawing(the clamp clamps the lens).

### DETAILED DESCRIPTION OF INVENTION

The invention is a structure for eyeglasses. In particular, it relates to the structure and method of setting the lens and front, wherein the structure allows for the lens to be easily removed and reassembled.

This is a structure for eyeglasses, which includes a frame and at least one lens. The frame has fronts, and the front formed a lens assemble area. On the assemble part of the front, there are recesses. Also, the frame has embedded clamps on the outside part of the front. Embedded clamps can be displaced outward to move away from the lens assemble area, or be displaced inward to inside the lens assemble area and clamp the lens.

More specifically, there is a perforation on the front of the eyeglasses. On the top flange or/and upper flange of the perforation, there is at least one detents. The embedded clamps has a bored segment which goes thorough the perforation. On the outer and inner sides of the bored segment, there are outer cover and inner cover. Also, on the bored segment, there is at least one detents which corresponds to the detents on the perforation. The detents on the bored segment can clip with the detents on the perforation to fix the embedded clamps.

In this structure, the outer cover and the bored segment is unified.

In this structure, there are trims on the outer side of the outer cover to make the displacement of the embedded clamps more convenient.

In this structure, there are a hole on the inner cover. On the bore segment, there is a corresponding locking hole. The screw can go through the hole and be locked in the locking hole. Therefore, the inner cover can be fixed on the bored segment.

When the lens is assembled into the lens assemble area, the embedded clamps can be displaced outward so that the embedded clamps does not prevent the lens assembling. After the lens is assembled into the lens assemble area, the clamps can be displaced inward to clamp the lens with its outer cover and inner cover. As such, the lens can be fixed in the front. Also, the clamps can be fixed by the detents of the bored segment and the perforation.

Advantages of this structure are as follows:
1. The removal and the assembly of the lens from the front requires no tools. Simply by controlling the clamps by hand, and moving the clamps away from the inner and outer surfaces of the lens, the lens can be removed or reassembled. It is a fairly easy way to remove or reassemble the lens.
2. The clamps with its outer cover and inner cover can fix the outer and inner surfaces of the lens. Therefore, because of the method and ease of assembling, the lens can still be assembled with the front, even if there are small differences between the size of the lens and the lens assemble area.
3. Also, because the clamps can be displaced outward to move away from the lens assemble area, the clamp does not preclude the lens from being assembled with the front.

### DETAILED DESCRIPTION OF THE DRAWINGS

In order to successfully achieve the purpose of the present invention, there is a thorough description. Please also refer to the illustration and component signs.

Please refer to the following table as drawing legend for the illustrations:
(1) frame
(11) front
(111) perforation
(112) first detents
(113) second detents
(14) clamp
(12) lens assembly area
(13) recess
(141) bored segment
(1411) locking hole
(142) outer cover
(1421) trim
(143) inner cover
(1431) hole
(144) screw
(145) detents
(2) lens

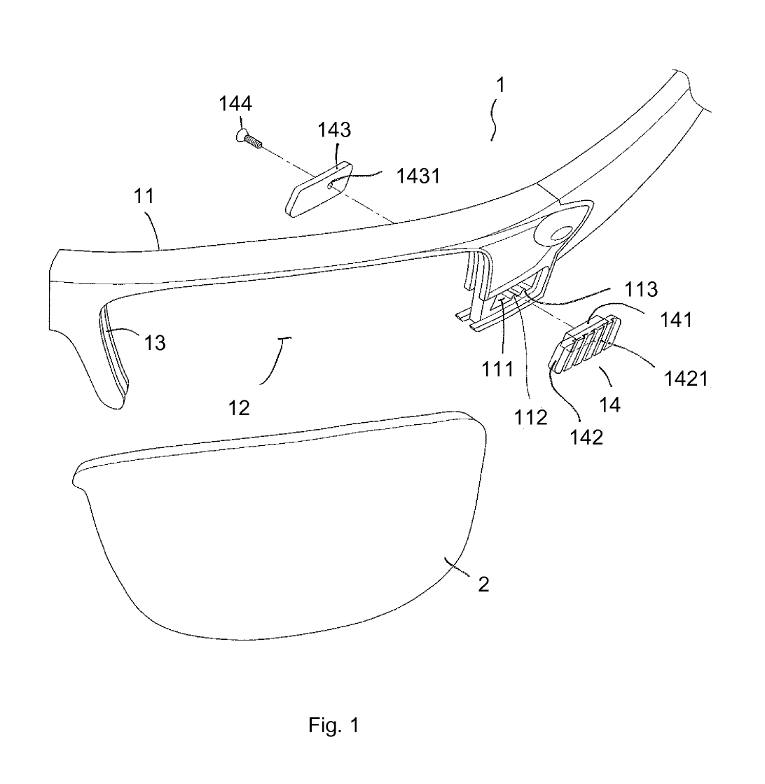

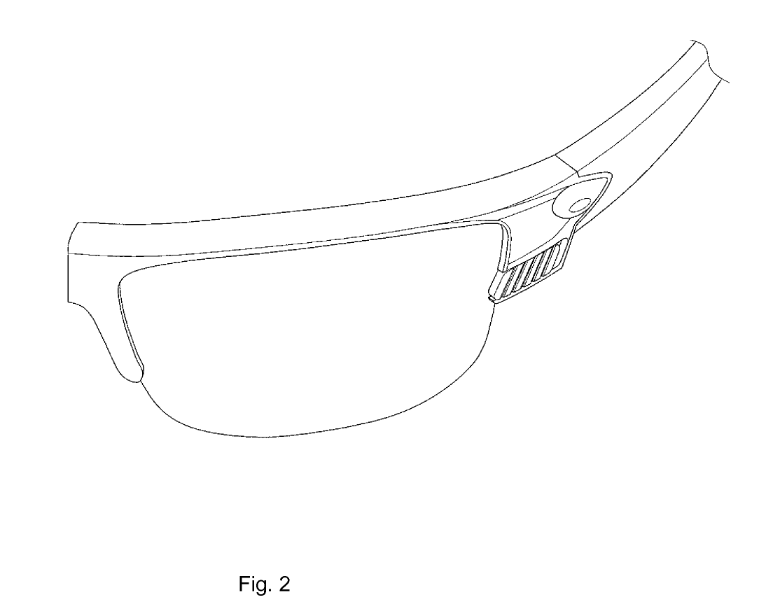

Please refer to FIGS. 1 and 2. It is the 3D decomposition of the structure of eyeglasses. The frame (1) includes a front (11), wherein the front(11) has at least one lens assemble area (12). On the edge wherein the lens (2) is assembled, there is a recess (13).

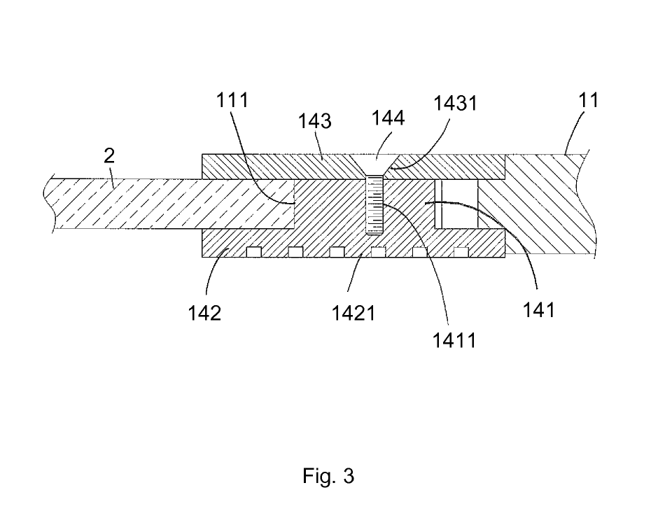

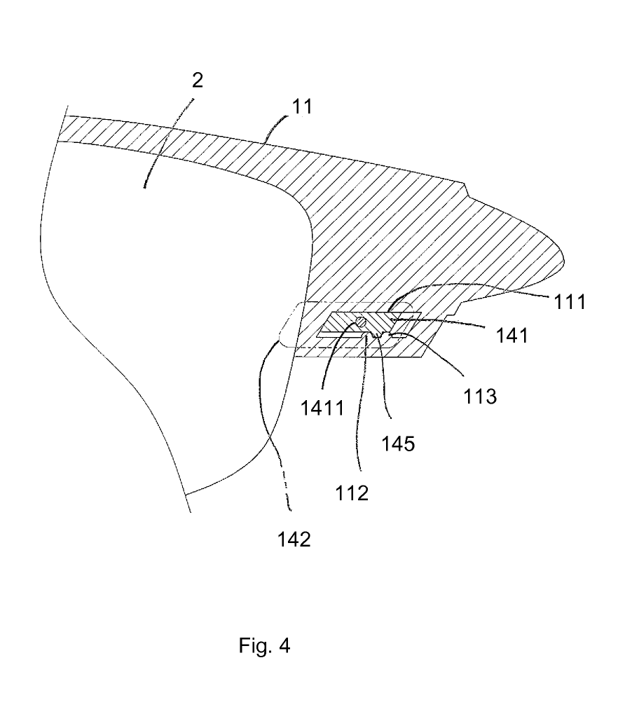

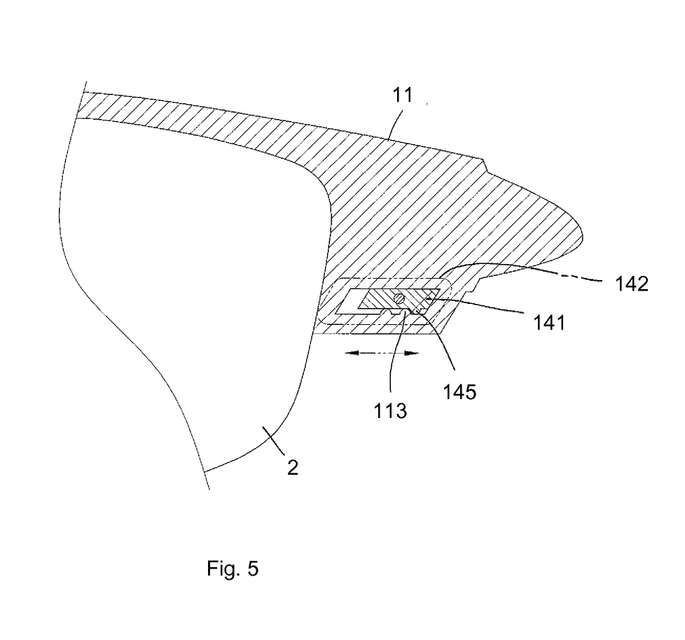

Please refer to FIGS. 3-5. On the front (11), there is a perforation (111). On the upper rim of the perforation (111), there are first detents (112) and second detents (113). On the front (11), there is a clamp (14) which can displaced outward to move away from lens assembly area (12) or be displaced inward to inside the lens assembly area (12) and clamps the lens (2). The clamp (14) contains a bored segment (141) which goes through the perforation (111). On the outer side and inner side of the bored segment (141), a outer cover (142) is joined with an inner cover (143). The bored segment (141) of the clamp (14) is combined with the outer cover (142), and there is trims (1421) on the outer surface of the outer cover (142) in order to draw the clamp (14). There is a hole (1431) on the inner cover (143). And on the bored segment (141) of the clamp (14), there is a locking hole (1411) corresponds the hole (1431). The screw (144) can go through the hole (1431) and be locked in the locking hole (1411) to be fixed the with inner cover (143) on the bored segment (141). Also, on the bored segment (141), there are detents (145) which corresponds to the first detents (112) and the second detents (113) in order to fix the displacement of the clamp (14).

When the lens (2) is assembled into the lens assemble area (11) of the front (1), the embedded clamps (14) can be displaced outward to the lens assemble area (11). When displacing the clamp (14), it moves the detents (145) on the bored segment (141) of the clamp (14) across the second detents (113) in order to fix the displacement status of clamp (14) with the lens assembly area (12). As such, the lens (2) does not interfere with the assembly of the lens to the assembly area (12). After the lens (2) is assembled into the lens assembly area (12) and the rims are inserts into the recess (13), the clamp (14) should move toward the lens assembly area (12). The detents (145) on the bored segment (141) of the clamp (14) is pulled across the second detents (113) and is fixed between the first detents (112) and the second detents (113). As such, the lens (2) can be fixed by the clamp (14) stably in the front (11).

When removing the lens (2) out of the lens assembly area (11) of the front (1), moving the clamp (14) outward to release the clamp (14) from the clamping the lens (2). Then, the lens (2) can be removed.

Therefore, with this structure, when removing or re-assembling the lens (2), there is no need of tools. When the clamp (14) is moved away from the lens (2), the lens is removed. On the other hand, when the clamp (14) is moved to clamp the lens (2), the lens (2) can attached. The operation is fairly easy. Furthermore, the clamp (14) can be displaced outward so that the clamp (14) does not stay inside the lens assembly area (12), thus, it does not dispute the assembling of lens (2). When the lens (2) is assembled with the front (11), the clamp (14) clamps the lens (2) on two sides. Therefore, because of the method and ease of assembling, the lens (2) can still be assembled with the front (11), even if there are small differences between the size of the lens (11) and the lens assemble area (12).

The instance described above should not be use to limit the invention. It describes one of the many embodiments. Therefore, many different embodiments are available with the invention disclosed herein.

As described above, the embodiments achieve the object of the invention. The particular structure has never be used in any other types of products nor be published to the public before the patent application. It has met the standard and requirement according to the patent law. Thereby, the applicant files the application for the patent.

What is claimed is:

1. An eyeglasses apparatus comprising a frame and at lease one lens wherein said frame comprising a lens assembly area wherein said lens assembly area is comprised of a recess and a clamp wherein said clamp attaches to said recess to secure said lens onto said lens assembly area.

2. The apparatus of claim 1 wherein said recess is comprised of a one or more threaded portion on said recess and said clamp is comprised of a bore segment, an inner cover and an outer cover; wherein said bore segment is comprised of a matching threaded portion wherein said matching threaded portion matches to said threaded portion of said recess.

3. The apparatus of claim 1 wherein said threaded portion of said recess is comprised of at least a first area and a second area wherein said clamp is moves along the edge of said recess as said clamp's matching threaded portion matches to said second area as oppose to said first area.

4. The apparatus of claim 2 wherein said clamp's bore segment is integral with said outer cover.

5. The apparatus of claim 2 wherein said clamp is comprised of a trim area.

6. The apparatus of claim 2 wherein said inner cover is comprised of a hole allowing a screw to attach said inner cover to said bore segment.
